(19) United States
(12) Patent Application Publication
(10) Pub. No.: US 2025/0293354 A1
(43) Pub. Date: Sep. 18, 2025

(54) POUCH-TYPE BATTERY

(71) Applicant: SAMSUNG SDI CO., LTD., Yongin-si (KR)

(72) Inventors: Sungill LIM, Yongin-si (KR); Jaehyeok CHOI, Yongin-si (KR)

(21) Appl. No.: 19/015,941

(22) Filed: Jan. 10, 2025

(30) Foreign Application Priority Data
Mar. 14, 2024 (KR) 10-2024-0035979

(51) Int. Cl. H01M 50/105; H01M 50/14

(52) U.S. Cl. CPC H01M 50/105; H01M 50/14

(57) ABSTRACT

A pouch-type battery is provided that includes an electrode assembly including a first electrode, a second electrode, and a separator. A pouch accommodates the electrode assembly such that at least a part of the first electrode and the second electrode are exposed to outside of the pouch. A protection tape is attached to a surface of the pouch and covers at least part of a sealing portion of the pouch. The protection tape includes a first fixing portion and a second fixing portion each extending from a lower end of the protection tape, with an end of the first fixing portion being arranged on a bottom surface of the pouch, and with the second fixing portion covering at least part of the first fixing portion.

### CROSS-REFERENCE TO RELATED APPLICATION

The present application claims priority and the benefit of Korean Patent Application No. 10-2024-0035979, filed on Mar. 14, 2024, in the Korean Intellectual Property Office, the entire disclosure of which is incorporated herein by reference in its entirety.

### BACKGROUND

### 1. Field

One or more embodiments relate to a pouch-type battery.

### 2. Description of the Related Art

Secondary batteries can be charged and discharged a plurality of times, thereby enabling repeated use. Secondary batteries are used as energy sources for mobile devices, electric vehicles, hybrid vehicles, electric bicycles, uninterruptible power supplies, etc. According to the type of external device in which they are used, secondary batteries can be configured in the form of a single battery or in the form of a module in which multiple battery cells are connected and grouped into one unit.

### SUMMARY

One or more embodiments include a pouch-type battery including a protection tape provided with a first fixing portion and a second fixing portion that are arranged on a bottom surface of a pouch.

One or more embodiments include a pouch-type battery in which a second fixing portion is arranged so as to not overlap an insulating portion on one side of a pouch.

Additional aspects will be set forth in part in the description which follows and, in part, will be apparent from the description, or may be learned by practice of the presented embodiments of the present disclosure.

According to one or more embodiments, a pouch-type battery includes an electrode assembly including a first electrode, a second electrode, and a separator, a pouch accommodating the electrode assembly with at least part of the first electrode and at least a part of the second electrode exposed to outside of the pouch, and a protection tape attached to a surface of the pouch and covering at least a part of a sealing portion of the pouch, in which the protection tape includes a first fixing portion and a second fixing portion each extending from a lower end of the protection tape, an end of the first fixing portion is arranged on a bottom surface of the pouch, and the second fixing portion covers at least part of the first fixing portion.

The first fixing portion and the second fixing portion may each be provided in plural.

The plurality of first fixing portions may extend in opposite directions on the bottom surface of the pouch.

The plurality of second fixing portions may extend in a direction intersecting a direction in which the plurality of first fixing portion extend.

The protection tape may include an insulating portion covering the sealing portion on a side of the pouch, and an end of the second fixing portion may be arranged on the side of the pouch on which the insulating portion is arranged.

The second fixing portion may be arranged so as to not overlap the insulating portion on the side of the pouch.

The insulating portion may include a slope structure such that the insulating portion does not overlap the second fixing portion.

The second fixing portion may include a slope structure such that the second fixing portion does not overlap the insulating portion.

The insulating portion and the second fixing portion may be spaced apart from each other on the side of the pouch.

The second fixing portion may include a 2nd-1 fixing portion covering the first fixing portion on a lower end of the pouch and a 2nd-2 fixing portion arranged on a side surface of the pouch.

The 2nd-2 fixing portion may be such that is does not overlap the insulating portion on the side surface of the pouch.

### BRIEF DESCRIPTION OF THE DRAWINGS

The above and other aspects, features, and advantages of certain embodiments of the present disclosure will be more apparent from the following description taken in conjunction with the accompanying drawings.

FIG. 1 is a perspective view of a pouch-type battery according to embodiments;

FIG. 2 is an assembly view of a pouch-type battery according to embodiments;

FIG. 3 is a view for describing a sealing portion of a pouch-type battery according to embodiments;

FIG. 4 is a planar view of a protection tape according to embodiments;

FIG. 5 is a perspective view of a pouch-type battery to which a protection tape is attached, according to embodiments;

FIG. 6 is a perspective view showing a part of a pouch-type battery according to a comparison example;

FIG. 7 is a perspective view showing a part of a pouch-type battery according to a comparison example;

FIG. 8 is a perspective view showing a state in which a first fixing portion is arranged on a bottom surface of a pouch, according to embodiments;

FIG. 9 is a perspective view showing a second fixing portion that covers a first fixing portion, according to embodiments;

FIG. 10 is a conceptual diagram for describing a slope structure included in a protection tape, according to embodiments; and

FIG. 11 is a conceptual diagram for describing a slope structure included in a protection tape, according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

Hereinafter, embodiments of the present disclosure will be described in detail with reference to the accompanying drawings. The terms and words used in the present specification and claims described above should not be construed as being limited to ordinary or dictionary meanings, and should be interpreted as meanings and concepts consistent with the technical idea of the present disclosure based on the principle that the present inventors may appropriately define the concept of the terms to describe their invention in the best way. Therefore, it should be understood that the configurations shown in the drawings and embodiments described in this specification are merely the most preferred embodiments of the present disclosure, and do not represent all of the technical ideas of the present disclosure, such that there may be various equivalents and variations that replace them at the time of filing the present application. If used herein, “comprise, include” and/or “comprising, including” specify mentioned shapes, numbers, steps, operations, members, components, and/or presence of these groups, and do not exclude the presence or addition of one or more different shapes, numbers, operations, members, components, and/or groups. If embodiments of the present disclosure are described, “can” or “may” may include “one or more embodiments of the present disclosure”.

To help understanding of the present disclosure, the accompanying drawings are not shown according to the actual scale, but the dimensions of some components may be exaggerated. The same reference numeral may be given to the same component in different embodiments.

The statement that two comparison targets are ‘the same” as each other may mean that they are “substantially the same” as each other. Thus, a case where they are “substantially the same” as each other may include a case where they have a deviation regarded as a low level, e.g., a deviation of 5% or less. If a uniform parameter is uniform in a predetermined area, it may mean that it is uniform from an average point of view.

Although first, second, etc., may be used to describe various components, these components are not limited by these terms. These terms are only used to distinguish one component from other components, and unless specifically stated to the contrary, a first component may be a second component.

Throughout the specification, unless specially stated to the contrary, each component may be singular or plural.

If a component is arranged on “a top portion (or a bottom portion)” of another component or “on (or under)” the other component, it may mean not only a case where the component is arranged adjacent to a top surface (or a bottom surface) of the other component, but also a case where another component may be interposed between the other component and the component arranged on (or under) the other component.

If a component is described as being “connected”, “coupled”, or “connected” to another component, it should be understood that the components are directly connected or connectable to each other, but another component may be “interposed” between the components, or the components may be may be “connected”, “coupled”, or “connected” to each other through another component. If a portion is electrically coupled to another portion, this may include not only a case where they are directly connected to each other, but also a case where they are connected with another element therebetween.

Throughout the specification, “A and/or B” may mean A, B, or A and B unless specially stated otherwise. That is, “and/or” may include all or any combination of a plurality of items listed. “C to D” may mean at least C but not more than D, unless specially stated otherwise.

Hereinafter, a battery heating device according to embodiments will be described with reference to the accompanying drawings.

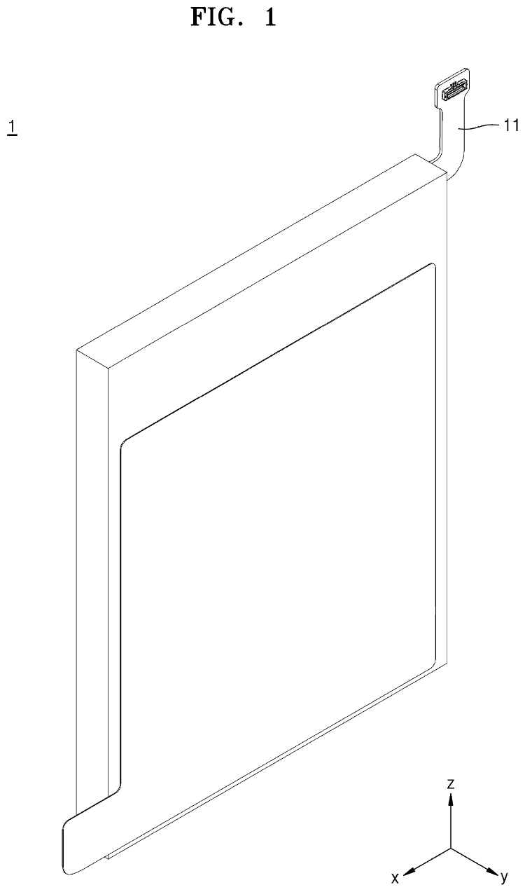

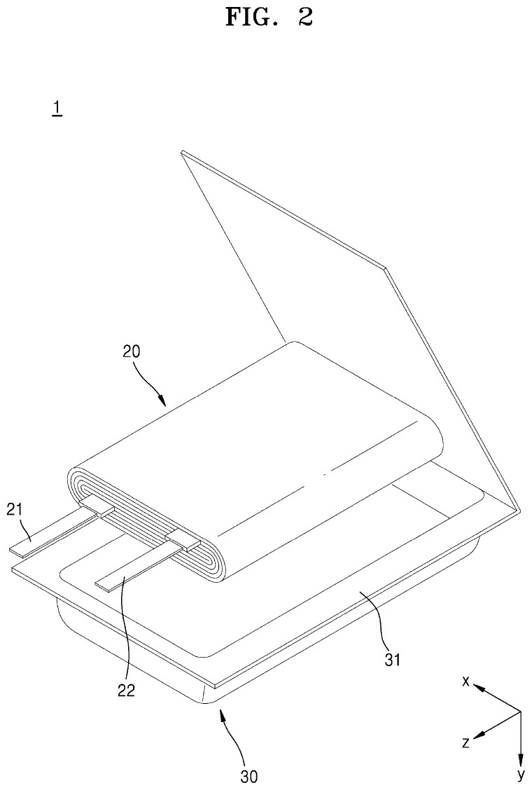

FIG. 1 is a perspective view of a pouch-type battery 1 according to embodiments. FIG. 2 is an assembly view of the pouch-type battery 1 according to embodiments.

Referring to FIGS. 1 and 2, the pouch-type battery 1 according to embodiments may include an electrode assembly 20. The electrode assembly 20 may include a negative plate, a positive plate, and a separator arranged between the negative and positive plates. A negative tab electrically connected to a negative uncoated portion may be provided in the negative plate, and a positive tab electrically connected to a positive uncoated portion may be provided in the positive plate. The negative tab may be a first electrode 21. The positive tab may be a second electrode 22.

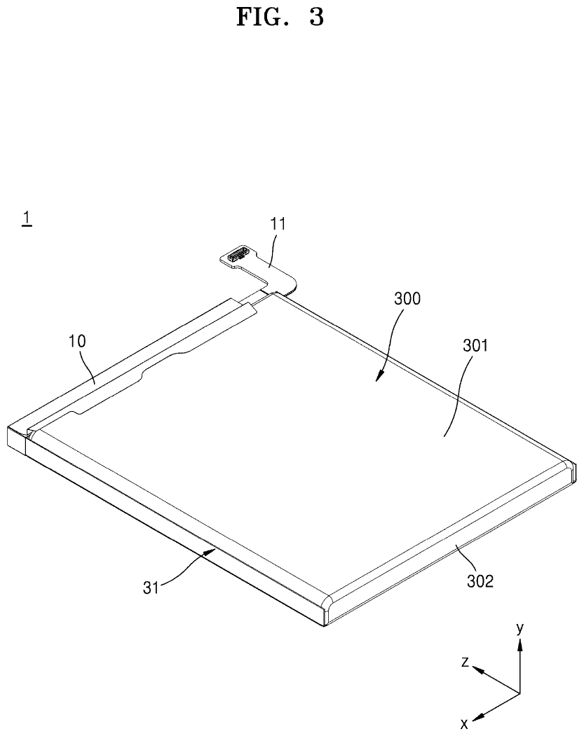

The pouch-type battery 1 according to embodiments may include a pouch 30 configured to accommodate the electrode assembly 20. That is, the electrode assembly 20 may be accommodated inside the pouch 30. At least part of the first electrode 21 and the second electrode 22 may be exposed to outside of the pouch 30. The first electrode 21 and the second electrode 22 exposed to the outside of the pouch 30 may be electrically connected to a protection circuit module 10 (described later with reference to FIG. 3).

The pouch 30 according to embodiments may be sealed by sealing portions 31 provided at an edge of the pouch 30 and meeting each other while the electrode assembly 20 is accommodated inside of the pouch 30. In such a case, the pouch 30 may be sealed in a state where a tab film (not shown) is arranged between the sealing portions 31. The sealing portions 31 of the pouch 30 may include a thermosetting material. The sealing portions 31 of the pouch 30 may be sealed by adhering thermosetting layers to each other. However, the foregoing description of a structure in which the pouch 30 accommodates the electrode assembly 20 and a structure in which the pouch 30 is sealed is merely an example, and the present disclosure is not limited in this regard.

FIG. 3 is a view for describing the sealing portion 31 of the pouch-type battery 1 according to embodiments.

Referring to FIGS. 1 to 3, the pouch-type battery 1 according to embodiments may include the pouch 30 that accommodates the electrode assembly 20 and is sealed by the sealing portions 31 meeting each other. The pouch 30 may accommodate the electrode assembly 20 and may be sealed by the sealing portions 31 meeting each other.

The pouch-type battery 1 according to embodiments may include the protection circuit module 10 and a connector 11. The protection circuit module 10 may be arranged on a top portion of the pouch-type battery 1. The top portion of the pouch-type battery 1 may be a direction in which at least part of the first electrode 21 and the second electrode 22 is exposed to outside of the pouch 30. The protection circuit module 10 may be electrically connected to the first electrode 21 and the second electrode 22 that are exposed in an upward direction from the pouch 30. The upward direction may be a first direction z as shown in the figures.

The connector 11 according to embodiments may be electrically connected to the protection circuit module 10. The connector 11 also may be electrically connected to an external device (not shown). Thus, the connector 11 may electrically connect the pouch-type battery 1 to the external device. The protection circuit module 10 may control output of electrical energy exchanged between the connector 11 and the pouch-type battery 1. For example, the protection circuit module 10 may control charging and discharging of the pouch-type battery 1. However, arrangements and functions of the protection circuit module 10 and the connector 11 are not limited to the foregoing description.

The sealing portions 31 of the pouch 30 according to embodiments may be folded to a side of a surface 300 of the pouch 30. Herein, the sealing portions 31 may be bonding portions of the pouch 30, which are formed on opposite sides of the pouch-type battery 1. For example, the sealing portions 31 may be folded onto a side surface 301 of the pouch 30. The sealing portions 31 may be folded toward the side surface 301 of the pouch 30. Herein, the side surface 301 of the pouch 30 may be the surface 300 of the pouch 30 formed in a second direction y on the external surface 300 of the pouch-type battery 1. The sealing portions 31 may be folded in the second direction y. However, the foregoing description of an arrangement of the sealing portions 31 is merely an example, and the present disclosure is not limited in this regard.

The sealing portions 31 of the pouch 30 may be covered with a protection tape 40, which will be described below.

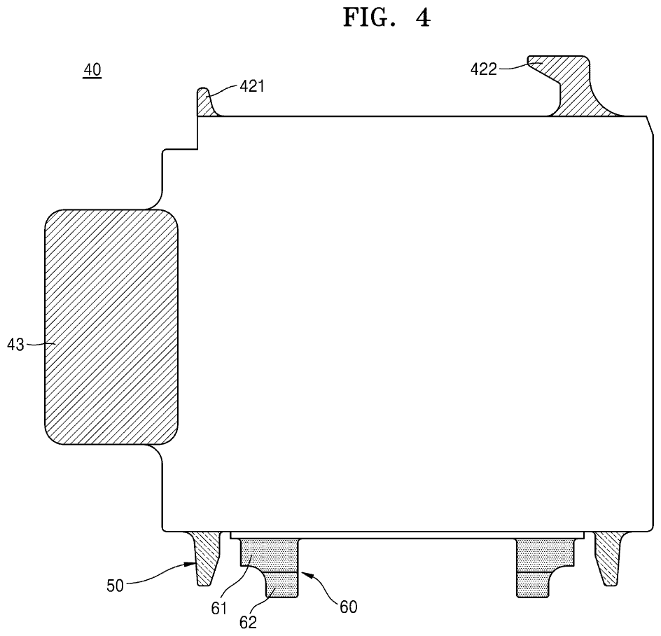

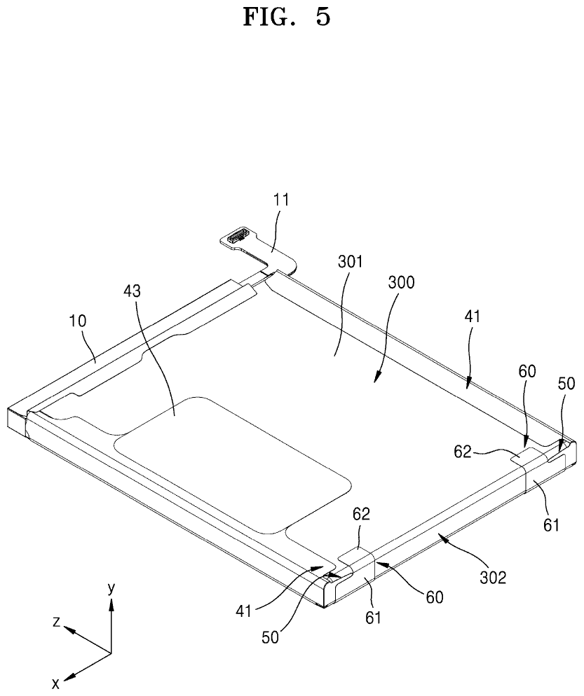

FIG. 4 is a planar view of the protection tape 40 according to embodiments. FIG. 5 is a perspective view of the pouch-type battery 1 to which the protection tape 40 is attached, according to embodiments.

Referring to FIGS. 3 to 5, the pouch-type battery 1 according to embodiments may include the protection tape 40. The protection tape 40 may be attached to the surface 300 of the pouch 30. The protection tape 40 may cover at least part of the surface 300 of the pouch 30. The protection tape 40 may cover at least part of the sealing portions 31 of the pouch 30. The sealing portions 31 of the pouch 30, covered with the protection tape 40, may be arranged on opposite sides of the side surface 301 of the pouch 30. The sealing portions 31 arranged on the opposite sides of the side surface 301 of the pouch 30 may be folded toward the side surface 301 of the pouch 30. The protection tape 40 may include an insulating material to thereby provide insulation to the sealing portions 31. However, the function of the protection tape 40 is not limited in this regard.

The protection tape 40 may be attached to surfaces of types of secondary batteries that are different from the pouch-type battery 1. For example, the protection tape 40 may be attached to a surface of a cylindrical battery or a prismatic battery.

The protection tape 40 according to embodiments may include an insulating portion 41 configured to cover the sealing portions 31 of the pouch 30. The protection tape 40 may include the insulating portion 41 arranged at opposite ends. For example, the insulating portion 41 included in the protection tape 40 may be arranged at opposite ends in a third direction x based on the planar view of the protection tape 40 of FIG. 4. As such, he insulating portion 41 may be arranged at opposite ends in the third direction x on the side surface 301 of the pouch 30 of FIG. 5. The insulating portion 41 may be referred to as a wing portion of the protection tape 40. The insulating portion 41 may be arranged on the sealing portions 31 of the pouch 30 as the protection tape 40 is attached onto the surface 300 of the pouch 30. The insulating portion 41 may be arranged to overlap the sealing portions 31 in the second direction y. That is, the second direction y may be a direction in which the sealing portions 31 of the pouch 30 are folded. The insulating portion 41 may include an insulating material to provide insulation to the sealing portions 31. However, an arrangement of the insulating portion 41 is not limited to the foregoing descriptions. For example, the insulating portion 41 may be arranged in a direction opposite to the sealing portions 31 on the surface 300 of the pouch 30. More specifically, the sealing portions 31 may be arranged on one side surface of the pouch 30, and the insulating portion 41 may be arranged on a side opposite to the one side surface.

The insulating portion 41 of the protection tape 40 may be provided to be attached onto a surface of a secondary battery of other types than the pouch-type battery 1. For example, the insulating portion 41 may provide insulation to a cylindrical battery. In such a case, the insulating portion 41 may extend on a surface of a cylindrical battery in a longitudinal direction of the cylindrical battery.

The protection tape 40 according to embodiments may be formed longer than a left-right width of the pouch 30. The left-right width of the pouch 30 may be a size of the pouch 30 in the third direction x as shown in the figures. Thus, the protection tape 40 may be formed greater than the size of the pouch 30 in the third direction x and the protection tape 40 may cover the entire one side of the pouch 30. Moreover, the protection tape 40 may cover the entire one side of the pouch 30 and at least part of the other side of the pouch 30 opposite to the one side. The protection tape 40 also may cover the entire one side of the pouch 30 while at least part of the other side opposite to the one side is not covered by the protection tape 40 so as to be exposed. The other side of the pouch 30 exposed by the protection tape 40 may be at least part of the side surface 301 of the pouch 30. The other side of the pouch 30 exposed by the protection tape 40 may be the surface 300 of the pouch 30 in a direction in which the insulating portion 41 is folded.

Referring to FIG. 5, the protection tape 40 may include the insulating portions 41 arranged at opposite ends in the third direction x. Referring back to FIGS. 3 to 5, the protection tape 40 may be attached along one side of the pouch 30, and one of the insulating portions 41 may be arranged on the other side opposite to the one side. As the protection tape 40 is attached to the surface 300 of the pouch 30, the insulating portions 41 may be arranged in opposite directions on the side surface 301 of the pouch 30. The insulating portions 41 may be arranged not to overlap a second fixing portion 60. A detailed configuration of the insulating portion 41 not overlapping the second fixing portion 60 will be described below.

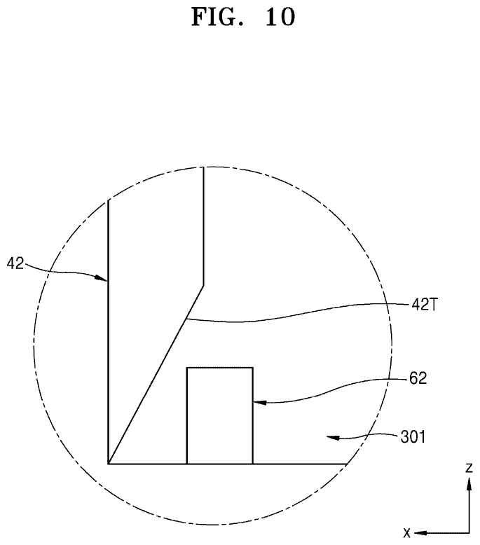

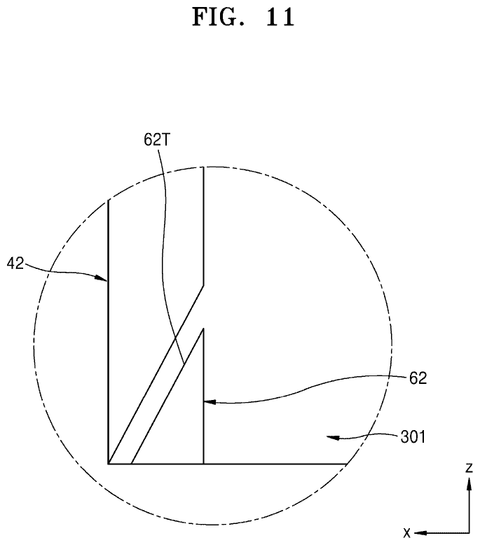

The protection tape 40 according to embodiments may include an upper end fixing portion 42 (see FIGS. 10 and 11) and a side fixing portion 43. The upper end fixing portion may extend from a top of the protection tape 40. The upper end fixing portion may include a first upper end fixing portion 421 and a second upper end fixing portion 422 that are spaced apart from each other in the third direction x. The side fixing portion 43 may extend from at least part of the insulating portion 41. The upper end fixing portion 42 and the side fixing portion 43 may fix relative positions of the pouch 30 and the protection tape 40 such that the protection tape 40 may be stably fixed onto the surface 300 of the pouch 30. However, functions and arrangements of the upper end fixing portion 42 and the side fixing portion 43 are not limited to the foregoing description.

Referring to FIG. 4, the protection tape 40 according to embodiments may include a first fixing portion 50 extending from a lower end thereof. The first fixing portion 50 may extend from the lower end of the protection tape 40 in a direction opposite to the first direction z. There may be a plurality of first fixing portions 50. For example, there may be two first fixing portions 50. The plurality of first fixing portions 50 may be spaced apart from each other on the lower end of the protection tape 40. The first fixing portion 50 may be arranged on the lower end of the pouch 30 as the protection tape 40 is attached onto the surface 300 of the pouch 30. Referring back to FIGS. 3 to 5, the first fixing portion 50 may extend from a bottom surface 302 of the pouch 30 in the third direction x. That is, an end of the first fixing portion 50 may be arranged on the bottom surface 302 of the pouch 30, and the first fixing portion 50 may be attached to the bottom surface 302 of the pouch 30. The bottom surface 302 of the pouch 30 may be the surface 300 of the pouch 30 formed on end opposite to the end of the pouch 30 on which the protection circuit module 10 is arranged. However, an arrangement of the first fixing portion 50 is not limited to the foregoing description.

The first fixing portion 50 of the protection tape 40 may be attached to lower ends of types of secondary batteries that are different from the pouch-type battery 1. For example, the first fixing portion 50 may be attached to a lower end of a cylindrical battery.

If there are a plurality of first fixing portions 50 (according to some embodiments), the plurality of first fixing portions 50 may extend from the bottom surface 302 of the pouch 30 in opposite directions. For example, two first fixing portions 50 may extend from the bottom surface 302 of the pouch 30 in opposite directions. The plurality of first fixing portions 50 may extend from the bottom surface 302 of the pouch 30 in a direction to be adjacent to each other. However, arrangements and the number of first fixing portions 50 are not limited to the foregoing description.

Referring to FIG. 4, the protection tape 40 according to embodiments may include a second fixing portion 60 extending from the lower end thereof. The second fixing portion 60 may extend from the lower end of the protection tape 40 in the direction opposite to the first direction z. There may be a plurality of second fixing portions 60. For example, there may be two second fixing portions 60. The plurality of second fixing portions 60 may be spaced apart from each other on the lower end of the protection tape 40. The plurality of second fixing portions 60 may be arranged between the first fixing portions 50 on the lower end of the protection tape 40. A plurality of the plurality of second fixing portions 60 may be arranged between the first fixing portions 50 on the lower end of the protection tape 40. For example, two first fixing portions 50 may be spaced apart from each other by a predetermined distance on the lower end of the protection tape 40, and two second fixing portions 60 may be arranged between the two first fixing portions 50. However, the number of second fixing portions 60 and an arrangement relationship with the first fixing portions 50 are not limited to the foregoing description.

The second fixing portion 60 of the protection tape 40 may be attached to lower ends of secondary batteries that are different from the pouch-type battery 1. For example, the second fixing portion 60 may be attached to a lower end of a cylindrical battery.

Referring back to FIGS. 3 to 5, the second fixing portion 60 may extend in a direction intersecting a direction in which the first fixing portion 50 extends. For example, the second fixing portion 60 may extend from the bottom surface 302 of the pouch 30 in the second direction y. The second direction y may be a direction intersecting the first direction z and a direction in which the first fixing portion 50 extends from the bottom surface 302 of the pouch 30. The second direction y in which the second fixing portion 60 extends from the bottom surface 302 of the pouch 30 may be a thickness direction of the pouch 30.

The second fixing portion 60 may extend from the bottom surface 302 of the pouch 30 in the second direction y and follow the surface 300 of the pouch 30, and an end of the second fixing portion 60 may be arranged on the side surface 301 of the pouch 30. The side surface 301 of the pouch 30 on which the end of the second fixing portion 60 is arranged may be one side of the pouch 30 in a direction in which the sealing portion 31 is folded. The side surface 301 of the pouch 30 on which the end of the second fixing portion 60 is arranged may be one side of the pouch 30 on which the insulating portion 41 is arranged. The end of the second fixing portion 60 may be arranged on one side of the pouch 30 on which the insulating portion 41 is arranged.

If the end of the second fixing portion 60 according to embodiments is arranged on the side surface 301 of the pouch 30, then at least part of the second fixing portion 60 extends from the side surface 301 of the pouch 30 in an upward direction of the pouch 30. That is, wehn the end of the second fixing portion 60 is arranged on the side surface 301 of the pouch 30, then at least part of the second fixing portion 60 extends from the side surface 301 of the pouch 30 in the first direction z. However, the number of second fixing portions 60 and an arrangement of an end of the second fixing portion 60 are not limited to the foregoing description.

Referring back to FIG. 4, the second fixing portion 60 according to embodiments may include a 2nd-1 fixing portion 61 and a 2nd-2 fixing portion 62. The 2nd-2 fixing portion 62 may extend from an end of the 2nd-1 fixing portion 61 in the direction opposite to the first direction z. The 2nd-2 fixing portion 62 may be formed to have narrower width than a width of the 2nd-2 fixing portion 61. The widths of the 2nd-2 fixing portion 62 and the 2nd-1 fixing portion 61 described above may be widths in the third direction x. The 2nd-2 fixing portion 62 may extend from a part of the end of the 2nd-1 fixing portion 61. If the 2nd-2 fixing portion 62 extends from a part of the end of the 2nd-1 fixing portion 61, then the 2nd-2 fixing portion 62 is spaced from one end side of the 2nd-1 fixing portion 61. The 2nd-2 fixing portion 62 may extend in the first direction z at a position spaced apart from the adjacent first fixing portion 50 to the 2nd-1 fixing portion 61. If there are a plurality of second fixing portions 60, the plurality of 2nd-2 fixing portions 62 may be arranged adjacent to each other in opposite directions on the 2nd-1 fixing portion 61.

Referring back to FIGS. 4 and 5, at least part of the second fixing portion 60 according to embodiments may be arranged on the bottom surface 302 of the pouch 30. A part of the second fixing portion 60 arranged on the bottom surface 302 of the pouch 30 may be the 2nd-1 fixing portion 61. That is, the 2nd-1 fixing portion 61 may be arranged on the bottom surface 302 of the pouch 30. At least part of the second fixing portion 60 may be arranged on the side surface 301 of the pouch 30. That is, a part of the second fixing portion 60 arranged on the side surface 301 of the pouch 30 may be the 2nd-2 fixing portion 62 and the 2nd-2 fixing portion 62 may be arranged on the bottom surface 302 of the pouch 30. The second fixing portion 60 extending from the bottom of the protection tape 40 may include the 2nd-1 fixing portion 61 extending on the bottom surface 302 of the pouch 30 in the second direction y and the 2nd-2 fixing portion 62 connected to the 2nd-1 fixing portion 61 and extending on the side surface 301 of the pouch 30 in the first direction z. However, arrangements of the 2nd-1 fixing portion 61 and the 2nd-2 fixing portion 62 are not limited in this regard. For example, at least part of the 2nd-1 fixing portion 61 may be arranged on the side surface 301 of the pouch 30 or at least part of the 2nd-2 fixing portion 62 may be arranged on the bottom surface 302 of the pouch 30. Thus, arrangements of the 2nd-1 fixing portion 61 and the 2nd-2 fixing portion 62 are not limited to the foregoing description.

The second fixing portion 60 may function to fix the first fixing portion 50 onto the bottom surface 302 of the pouch 30. The function of the first fixing portion 50 will be described before the detailed description of the function of the second fixing portion 60.

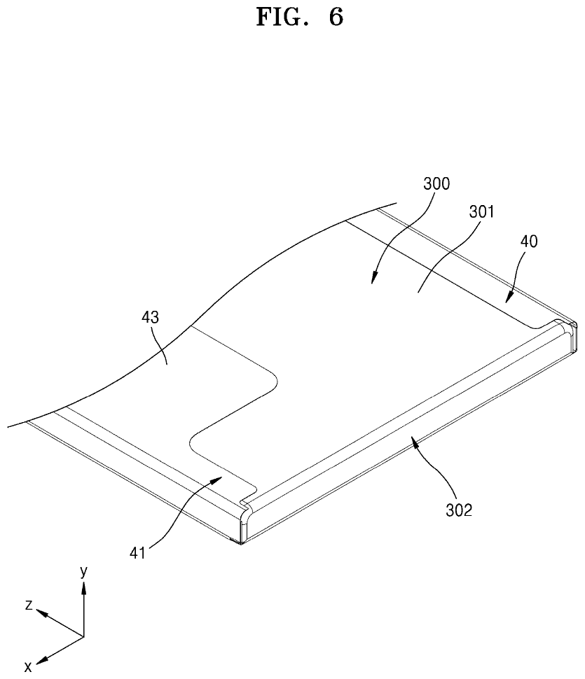

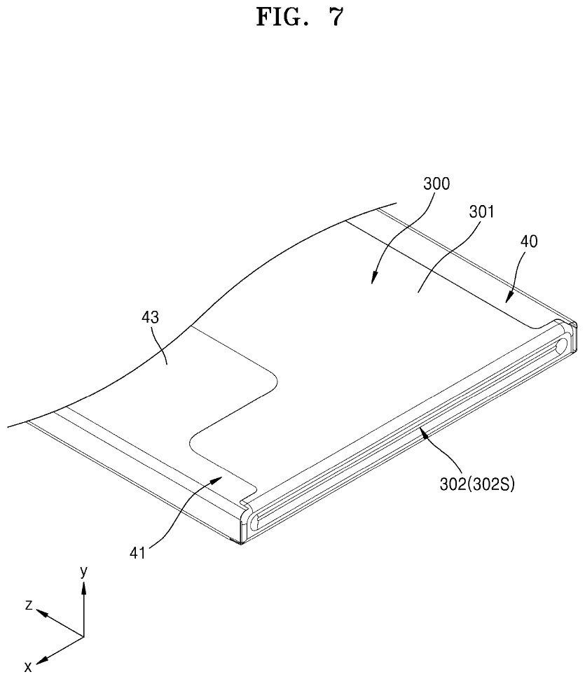

FIG. 6 is a perspective view showing a part of the pouch-type battery 1 according to a comparison example. FIG. 7 is another perspective view showing a part of the pouch-type battery 1 according to the comparison example.

Referring to FIGS. 6 and 7, the pouch-type battery 1 according to a comparison example may be the pouch-type battery that does not include the first fixing portion 50 described above. The pouch-type battery of FIG. 6 may have attached thereto the protection tape 40 but not the first fixing portion 50. It is shown in FIG. 7 that the bottom surface 302 of the comparison example is deformed after an activation process.

more specifically, after the protection tape 40 is attached onto the pouch 30, the activation process of the pouch-type battery 1 may be performed. The activation process of the pouch-type battery 1 may include a process of discharging gas from inside the pouch 30 to outside of the pouch 30. If the gas inside the pouch 30 is discharged in the activation process of the pouch-type battery 1, a negative pressure may be formed inside the pouch 30. And if the negative pressure is formed inside the pouch 30, then the surface 300 of the pouch 30 may be deformed. If the negative pressure is formed inside the pouch 30, a part of the surface 300 of the pouch 30 have little area may not have great resistance to deformation. For example, the bottom surface 302 of the pouch 30 may have a less area than the side surface 301. Thus, the bottom surface 302 of the pouch 30 may be deformed due to the negative pressure formed inside the pouch 30. As such, the bottom surface 302S of the pouch 30 may be sucked toward inside of the pouch 30 in the activation process of the pouch-type battery 1. Specifically, the bottom surface 302S of the pouch 30 may become concave toward the inside of the pouch 30 in the activation process of the pouch-type battery 1. However, a cause of deformation of the bottom surface 302S of the pouch 30 is not limited to the foregoing description. For example, the bottom surface 302S of the pouch 30 may become concave toward the inside of the pouch 30 during a process of charging and/or discharging the pouch-type battery 1 after the activation process of the pouch-type battery 1. If the bottom surface 302S of the pouch 30 is concaved inward, the appearance of the pouch-type battery 1 may be degraded. Further if the bottom surface 302S of the pouch 30 is concaved inward, the volumetric efficiency of the pouch-type battery 1 may be degraded.

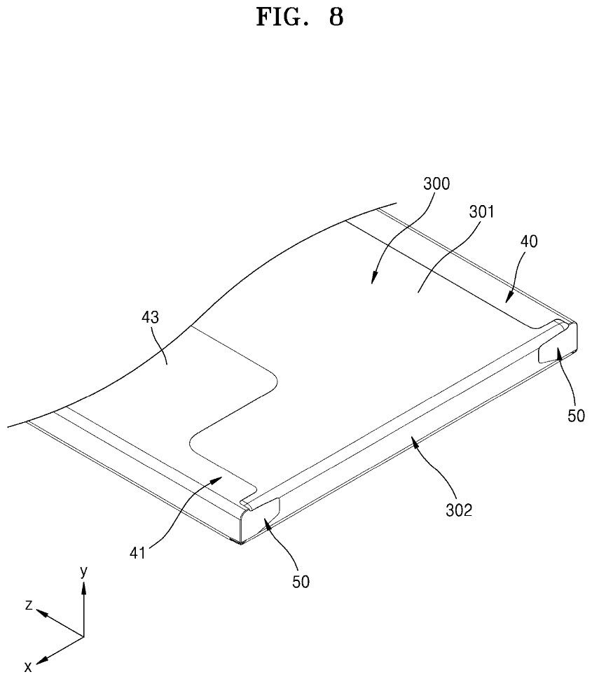

FIG. 8 is a perspective view showing a state in which the first fixing portion 50 is arranged on the bottom surface 302 of the pouch 30, according to embodiments of the disclosure.

Referring to FIG. 8, the first fixing portion 50 may be attached to the bottom surface 302 of the pouch 30 such that the first fixing portion 50 supports a bottom of the pouch 30. The first fixing portion 50 may thereby prevent the bottom surface 302 of the pouch 30 from being concaved inward. That is, the first fixing portion 50 may prevent the bottom surface 302 of the pouch 30 from being sucked inward. However, the function of the first fixing portion 50 is not limited in this regard.

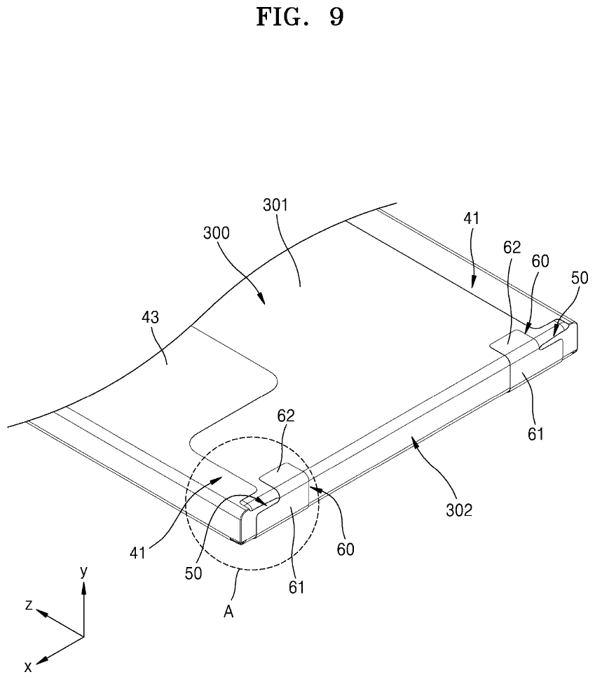

FIG. 9 is a perspective view showing the second fixing portion 60 that covers the first fixing portion 50, according to embodiments of the disclosure.

Referring to FIGS. 8 and 9, the second fixing portion 60 according to embodiments may cover at least part of the first fixing portion 50. The second fixing portion 60 may cover at least part of the first fixing portion 50 such that the first fixing portion 50 is fixed on the bottom surface 302 of the pouch 30. Thus, the second fixing portion 60 may fix the first fixing portion 50 on the surface 300 of the pouch 30 such that the first fixing portion 50 prevents the bottom surface 302 of the pouch 30 from being concaved inward.

The 2nd-1 fixing portion 61 according to embodiments may cover the first fixing portion 50 on the lower end of the pouch 30. The lower end of the pouch 30 may be the bottom surface 302 of the pouch 30. The first fixing portion 50 may be disposed between the bottom surface 302 of the pouch 30 and the 2nd-1 fixing portion 61. However, the arrangement and number of 2nd-1 fixing portions 61 are not limited to the foregoing description.

The 2nd-2 fixing portion 62 according to embodiments may be arranged on the side surface 301 of the pouch 30. The 2nd-2 fixing portion 62 may support the 2nd-1 fixing portion 61 at a side thereof such that the 2nd-1 fixing portion 61 fixes the first fixing portion 50. The 2nd-2 fixing portion 62 may be fixed on the side surface 301 of the pouch 30 to fix the 2nd-1 fixing portion 61. However, the arrangement and number of 2nd-2 fixing portions 62 are not limited to the foregoing description.

The second fixing portion 60 may extend in the direction intersecting the direction in which the first fixing portion 50 extends. More specifically, the first fixing portion 50 may extend in a direction parallel to the third direction x on the bottom surface 302 of the pouch 30 The 2nd-1 fixing portion 61 may extend from the bottom surface 302 of the pouch 30 in the second direction y. As shown in the figures, the second direction y may intersect the third direction x. The 2nd-2 fixing portion 62 may extend along the side surface 301 of the pouch 30 in the first direction z. As shown in the figures, the first direction z may intersect the third direction x. As the second fixing portion 60 extends in the direction intersecting the direction in which the first fixing portion 50 extends, the second fixing portion 60 may effectively fix the first fixing portion 50 to the pouch 30.

The insulating portion 41 and the second fixing portion 60 may be arranged so as to not overlap each other on one side of the pouch 30. And the protection tape 40, the insulating portion 41, and the second fixing portion 60 may be arranged so as to not overlap one another on the side surface 301 of the pouch 30 in the second direction y. The second direction y may be the thickness direction of the pouch-type battery 1. If the insulating portion 41 and the second fixing portion 60 are arranged so as to not overlap each other on the side surface 301 of the pouch 30 in the second direction y, the thickness of the pouch-type battery 1 may not be increased. If the insulating portion 41 and the second fixing portion 60 are arranged so as to not overlap each other on the side surface 301 of the pouch 30 in the second direction y, the pouch-type battery 1 may have a high volumetric efficiency.

If the protection tape 40 is attached to the pouch 30, the insulating portion 41 and the 2nd-2 fixing portions 62 may be arranged on the same surface 300 of the pouch 30. For example, the insulating portion 41 and the 2nd-2 fixing portions 62 may be arranged on the side surface 301 of the pouch 30. The insulating portion 41 and the 2nd-2 fixing portions 62 may be arranged not to overlap each other on the side surface 301 of the pouch 30. If the insulating portion 41 and the 2nd-2 fixing portions 62 are arranged so as to not overlap each other on the side surface 301 of the pouch 30, the pouch-type battery 1 may have a high volumetric efficiency. However, the arrangement and relationship of the insulating portion 41 and the 2nd-2 fixing portions 62 is not limited to the foregoing description.

The insulating portion 41 and the second fixing portion 60 according to embodiments may be spaced apart from each other by a predetermined distance on one side of the pouch 30. The 2nd-2 fixing portion 62 may be spaced apart by a predetermined distance from the insulating portion 41 so as to not overlap the insulating portion 41 on the side surface 301 of the pouch 30. If the 2nd-2 fixing portion 62 is spaced apart from the insulating portion 41, it may mean that the 2nd-2 fixing portion 62 is spaced apart by the predetermined distance on the end of the 2nd-1 fixing portion 61 in a direction away from the insulating portion 41. The direction away from the insulating portion 41 on the end of the 2nd-1 fixing portion 61 may be a direction toward a center of the pouch-type battery 1 in the third direction x. The position where the 2nd-2 fixing portion 62 is disposed relative to the 2nd-1 fixing portion may be toward the inside of the pouch-type battery 1 in the third direction x. Thus, the 2nd-2 fixing portion 62 may be spaced apart from the insulating portion 41 in an inward direction and thereby not overlap the insulating portion 41 on the side surface 301 of the pouch 30.

If there are a plurality of second fixing portions 60 according to embodiments of the disclosure, such as two second fixing portions 60, the plurality of second fixing portions 60 may be arranged at opposite sides in the first direction z on the lower end of the pouch 30. If the 2nd-2 fixing portion 62 included in each of the plurality of second fixing portions 60 extends from the 2nd-1 fixing portion 61, and the 2nd-2 fixing portions 62 may be spaced apart from each other on the side surface 301 of the pouch 30 in opposite directions. However, arrangements of the 2nd-2 fixing portion 62 and the 2nd-1 fixing portion 61 are not limited to the foregoing description. For example, there may be various arrangements of the 2nd-2 fixing portion 62 such that the 2nd-2 fixing portion 62 does not overlap the insulating portion 41 on the side surface 301 of the pouch 30.

If the 2nd-2 fixing portions 62 are excessively spaced apart on the side surface 301 of the pouch 30, a function of the 2nd-2 fixing portions 62 to fix the 2nd-1 fixing portions 61 may be reduced. Hereinbelow, a description will be made of a slope structure configured such that the 2nd-2 fixing portions 62 efficiently fix the 2nd-1 fixing portions 61 without being excessively spaced apart on the side surface 301 of the pouch 30.

FIG. 10 is a conceptual diagram for describing a slope structure 42T included in the protection tape 40 according to embodiments of the disclosure. FIG. 11 is a conceptual diagram for describing the slope structure 62T included in the protection tape 40 according to other embodiments of the disclosure. FIGS. 10 and 11 show an enlargement of the area A in FIG. 9.

Referring to FIGS. 10 and 11, the upper end fixing portion 42 of the insulating portion 41 according to embodiments may include the slope structure 42T. The slope structure 42T may prevent overlap with the 2nd-2 fixing portion 62 of the second fixing portion 60. Thus, the insulating portion 41 may cover a substantial area of the pouch 30 on the side surface 301 while also being spaced apart from the second fixing portion 60 because of the slope structure 42T. Also because of the slope structure 42T of the insulating portion 41, the 2nd-2 fixing portion 62 may efficiently fix the 2nd-1 fixing portion 61 on the side surface 301 of the pouch 30.

The second fixing portion 60 according to embodiments may include a slope structure 62T to prevent overlapping with the upper end fixing portion 42 of the insulating portion 41. in particular, the 2nd-2 fixing portion 62 may include the slope structure 62T to prevent overlapping with the upper end fixing portion 42 of the insulating portion 41. The 2nd-2 fixing portion 62 may efficiently fix the 2nd-1 fixing portion 61 while being spaced apart from the insulating portion 41 because of the slope structure 62T.

Although the present disclosure has been described with reference to an example shown in the drawings, it will be understood by those of ordinary skill in the art that various modifications and equivalent other examples may be made from the shown example.

The pouch-type battery according to the present disclosure may prevent the bottom surface of the pouch from being deformed through the first fixing portion arranged on the bottom surface of the pouch. And the pouch-type battery according to the present disclosure may prevent the bottom surface of the pouch from being deformed through the second fixing portion covering at least part of the first fixing portion.

The pouch-type battery according to the present disclosure may provide a miniaturized pouch-type battery because the second fixing portion is arranged so as to not overlap the insulating portion of the pouch.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims.

What is claimed is:

1. A pouch-type battery comprising:
an electrode assembly comprising a first electrode, a second electrode, and a separator;
a pouch accommodating the electrode assembly with at least part of the first electrode and at least a part of the second electrode exposed to outside of the pouch; and
a protection tape attached to a surface of the pouch and covering at least a part of a sealing portion of the pouch,
wherein the protection tape includes a first fixing portion and a second fixing portion each extending from a lower end of the protection tape,
wherein an end of the first fixing portion is arranged on a bottom surface of the pouch, and
wherein the second fixing portion covers at least part of the first fixing portion.

2. The pouch-type battery as recited in claim 1, wherein a plurality of the first fixing portion and a plurality of the second fixing portion provided.

3. The pouch-type battery as recited in claim 2, wherein the plurality of first fixing portions extend in opposite directions on the bottom surface of the pouch.

4. The pouch-type battery as recited in claim 3, wherein the plurality of the second fixing portions extend in a direction intersecting a direction in which the plurality of first fixing portions extend.

5. The pouch-type battery as recited in claim 1, wherein the protection tape comprises an insulating portion covering the sealing portion on a side of the pouch, and
wherein an end of the second fixing portion is arranged on the side of the pouch on which the insulating portion is arranged.

6. The pouch-type battery as recited in claim 5, wherein the second fixing portion is arranged so as to not overlap the insulating portion on the side of the pouch.

7. The pouch-type battery as recited in claim 6, wherein the insulating portion includes a slope structure such that the insulating portion does not overlap the second fixing portion.

8. The pouch-type battery as recited in claim 7, wherein the second fixing portion includes a slope structure such that the second fixing portion does not overlap the insulating portion.

9. The pouch-type battery recited in claim 8, wherein the insulating portion and the second fixing portion are spaced apart from each other on the side of the pouch.

10. The pouch-type battery as recited in claim 6, wherein the second fixing portion comprises:
a 2nd-1 fixing portion covering the first fixing portion on a lower end of the pouch; and
a 2nd-2 fixing portion arranged on a side surface of the pouch.

11. The pouch-type battery as recited in claim 10, wherein the 2nd-2 fixing portion does not to overlap the insulating portion on the side surface of the pouch.
